(19) United States
(12) Patent Application Publication
(10) Pub. No.: US 2015/0170120 A1
(43) Pub. Date: Jun. 18, 2015

(54) METHOD OF PROVIDING PAYMENT SERVICES AND MESSENGER SERVER USING THE METHOD

(71) Applicant: Samsung Electronics Co., Ltd., Suwon-si (KR)

(72) Inventor: Sung-Min JANG, Bucheon-si (KR)

(21) Appl. No.: 14/566,159

(22) Filed: Dec. 10, 2014

(30) Foreign Application Priority Data
Dec. 16, 2013 (KR) 10-2013-0156353

(51) Int. Cl. G06Q 20/12

(52) U.S. Cl. CPC G06Q 20/12

(57) ABSTRACT

A method of providing payment services and a messenger server providing the payment services using the method are provided. Also, provided are a messenger application providing payment services and a method of providing the payment services using the messenger application. According to embodiments, when a messenger server receives a request for a payment of goods selected by a user from a seller server, it is determined whether payment information of a user previously registered before the payment is sharable by the seller server. When the payment information is sharable, a signal requesting the payment of the goods is transmitted to a payment server using the payment information of the user, thereby allowing the payment of the goods selected by the user.

### CROSS-REFERENCE TO RELATED APPLICATION(S)

This application claims the benefit under 35 U.S.C. §119(a) of a Korean patent application filed on Dec. 16, 2013 in the Korean Intellectual Property Office and assigned Serial number 10-2013-0156353, the entire disclosure of which is hereby incorporated by reference.

### TECHNICAL FIELD

The present disclosure relates to a method of providing payment services and messenger server using the method.

### BACKGROUND

Recently, payment services of users for purchasing goods have been diversified. For example, users may access a seller server and may input payment information to purchase goods. Otherwise, users may integrate and manage several types of cards and a security card for payment using wallet applications. Otherwise, users may allow a user terminal device having a near field communication (NFC) unit to be in close proximity with a payment processing apparatus to purchase goods.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of improving accessibility of users using payment services and integrating payment services present in for each seller server is necessary.

When accessing a seller server and purchasing goods, users utilize a mutually different interface for each seller server to perform a payment. Also, since it is not possible to share payment information of users among sellers, there is inconvenience of inputting the payment information whenever users access a seller server. Also, when using wallet applications, users use wallet applications generally to manage points and membership of several types of cards. Due to this, users install an application for performing a payment in addition to wallet applications. Accordingly, a method of improving accessibility of users using payment services and integrating payment services present in for each seller server is desired.

An aspect of the present disclosure is to provide a method and an apparatus for addressing limitations described above.

Another aspect of the present disclosure is to provide a method and an apparatus for overcoming other limitations obvious to those skilled in the art.

In accordance with an aspect of the present disclosure, a method of providing payment services of a messenger server allowing a user to log thereon through a messenger application installed in a user terminal device is provided. The method includes receiving a signal requesting a payment for goods selected by the user from a seller server, determining, in response to the signal requesting the payment, payment information of the user, registered before the payment, to be sharable by the seller server when a seller using the seller server is present in a group consisting of opponents designated by the user through the messenger application among opponents of the user, registered in the messenger server, transmitting a signal requesting the payment for the goods to a payment server using the payment information when the payment information is sharable, and receiving a signal notifying that the payment of the goods is completed, from the payment server.

In accordance with an aspect of the present disclosure, a method of providing payment services using a messenger application installed in a user terminal device is provided. The method includes transmitting payment information of a user to a messenger server before a payment, displaying one or more sellers allowed to share the payment information with the messenger server through the messenger application, receiving a selection of at least one seller to share the payment information from the one or more sellers, and displaying a visual feedback notifying that the selected seller is allowed to share the payment information.

In accordance with an aspect of the present disclosure, a method of providing payment services of a user terminal device is provided. The method includes displaying an interface for purchasing goods, displaying a message for confirming the purchase of the goods on a messenger screen provided by a messenger application, in response to a request of a user for purchasing the goods through the interface, and displaying a visual feedback notifying that a payment of the goods is completed, when an agreement about the goods is confirmed as a response with respect to the displayed message.

In accordance with an aspect of the present disclosure, a messenger server allowing a user to log thereon through a messenger application installed in a user terminal device is provided. The messenger server includes a processor configured to, in response to a signal requesting a payment of goods selected by the user from a seller server, when a seller using the seller server is present in a group consisting of opponents designated by the user through the messenger application from opponents of the user registered in the messenger server, determine payment information of the user to be sharable by the seller server and a communication unit configured to, when the payment information is sharable, transmit a signal requesting the payment of the goods to a payment server allowed to pay for the goods through the payment information and receive a signal notifying that the payment of the goods is completed, from the payment server.

In accordance with an aspect of the present disclosure, a user terminal device is provided. The user terminal device includes a memory configured to store payment information of a user, a display unit configured to display a screen provided by a messenger application, and a processor configured to transmit the payment information to a messenger server before a payment, to receive a selection of at least one seller allowed to share the payment information through the messenger application interworking with the messenger server, and to control a visual feedback notifying that the selected at least one seller is allowed to share the payment information to be displayed on the display unit.

In accordance with an aspect of the present disclosure, a user terminal device is provided. The user terminal device includes a display unit configured to display an interface for purchasing goods and a processor configured to, in response to a request of a user for purchasing the goods through the interface, control a message for confirming the purchase of the goods on messenger screen provided by a messenger application to be displayed on the display unit.

In accordance with an aspect of the present disclosure, a recording medium recorded with a program for performing a method of providing payment services is provided. The method includes receiving a signal requesting a payment for goods selected by the user from a seller server, determining, in response to the signal requesting the payment, payment information of the user, registered before the payment, to be sharable by the seller server when a seller using the seller server is present in a group consisting of opponents designated by the user through the messenger application among opponents of the user, registered in the messenger server, transmitting a signal requesting the payment for the goods to a payment server using the payment information when the payment information is sharable, and receiving a signal notifying that the payment of the goods is completed, from the payment server.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view of a payment system for providing payment services according to an embodiment of the present disclosure;

FIG. 2 is a configuration view of a user terminal device according to an embodiment of the present disclosure;

FIG. 3 is a configuration view of a messenger server according to an embodiment of the present disclosure;

FIG. 4 is a view of a process of registering payment information of a user terminal device according to an embodiment of the present disclosure;

FIG. 5 is a view of a process of registering payment information using a messenger application in a user terminal device according to an embodiment of the present disclosure;

FIG. 6 is a view of a process of registering a seller as a friend of a user of a user terminal device according to an embodiment of the present disclosure;

FIGS. 7A and 7B are views of a process of registering a seller as a friend of a user using a messenger application in a user terminal device according to an embodiment of the present disclosure;

FIG. 8 is a view of a process of performing a payment while a user terminal device is interworking with a messenger server according to an embodiment of the present disclosure;

FIGS. 9A and 9B are views of a process of performing a payment using a messenger application in a user terminal device according to an embodiment of the present disclosure;

FIG. 10 is a flowchart illustrating a method of providing payment services while a messenger server is interworking with a seller server according to an embodiment of the present disclosure;

FIG. 11 is a flowchart illustrating a method, in which a user terminal device puts a seller on a friend list using a messenger application according to an embodiment of the present disclosure; and

FIG. 12 is a flowchart illustrating a method, in which a user terminal device provides payment services using a messenger application according to another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Similarly, in the drawings, some elements may be exaggerated or omitted or schematically illustrated. The size of each element does not entirely reflect a real size thereof. Accordingly, the size will not be limited to a relative size or interval shown in the attached drawings.

Also, as used herein, the singular forms “a,” “an” and “the” are intended to include the plural forms as well, unless the context clearly indicates otherwise. Also, the term “and” used herein indicates and includes all available combinations of one or more listed components.

Also, the terms “unit” and “module” disclosed herein indicate a unit performing at least one function or operation, which may be formed of hardware, software, or a combination thereof.

Herein, the embodiments will be described with reference to the attached drawings.

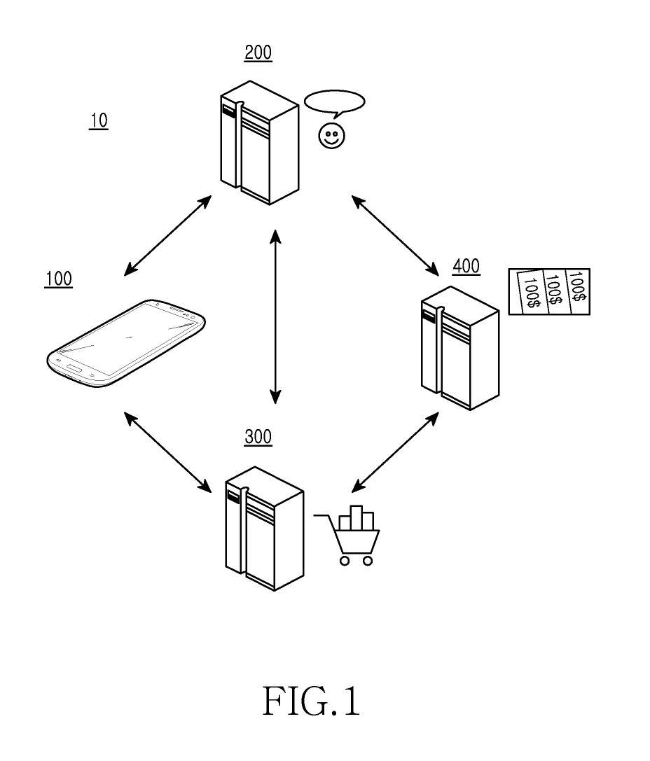

FIG. 1 is a view of a payment system 10 for providing payment services according to an embodiment of the present disclosure.

Referring to FIG. 1, the payment system 10 may include a user terminal device 100, a messenger server 200, a seller server 300, and a payment server 400.

The user terminal device 100 may be a device possessed or accompanied by a user. A configuration of the user terminal device 100 may be applied generally to a smart phone but is not limited thereto and may be applied to various electronic devices. For example, the configuration of the user terminal device 100 may be applied to a desktop personal computer (PC), a laptop PC, a portable multimedia player (PMP), personal digital assistants (PDA), a television (TV), a digital video disk (DVD) player, an electronic frame, a washer, an air-conditioner, a cleaner, a refrigerator, all types of medical instruments such as a magnetic resonance angiography (MRA) device, a magnetic resonance imaging (MRI) device, a computed tomography device, an ultrasound device, a navigation system, a black box, a set-top box, and a wearable device such as a wrist watch and a head-mounted display (HMD).

The messenger server 200 may transmit a message of a user to an external device or may receive a message of the user from the external device and may transmit the message to the user terminal device 100 while interworking with a messenger application installed in the user terminal device 100. Otherwise, the messenger server 200 may perform payment services for payment for goods that the user would like to purchase, while interworking with the seller server 300 and the payment server 400. The user may log on the messenger server 200 to receive or transmit a message through the messenger server 200. To log on the messenger server 200, the user may log on by inputting an identification (ID) and a password of a user's account whenever the messenger application is executed or may set up to automatically log on whenever the messenger server is executed.

The seller server 300 may be a server operated by management of a seller. The seller, for example, may be a provider of a large online open market such as Auction, list, eBay, and Interpark. Otherwise, the seller may be an operator of a small online shopping mall. The seller server 300 may correspond to a single seller. For example, when a plurality of sellers pay a certain bill, respectively, and share a single server, portions of a memory and processor of a common server may be allocated to sellers, respectively, and may operate as the seller server 300. The seller server 300 may perform payment services while interworking with the messenger server 200.

The payment server 400 may be a server of a card company processing payment of goods that the user would like to purchase. The payment server 400 may receive payment information from the messenger server 200 and may perform the payment of the goods that the user would like to purchase.

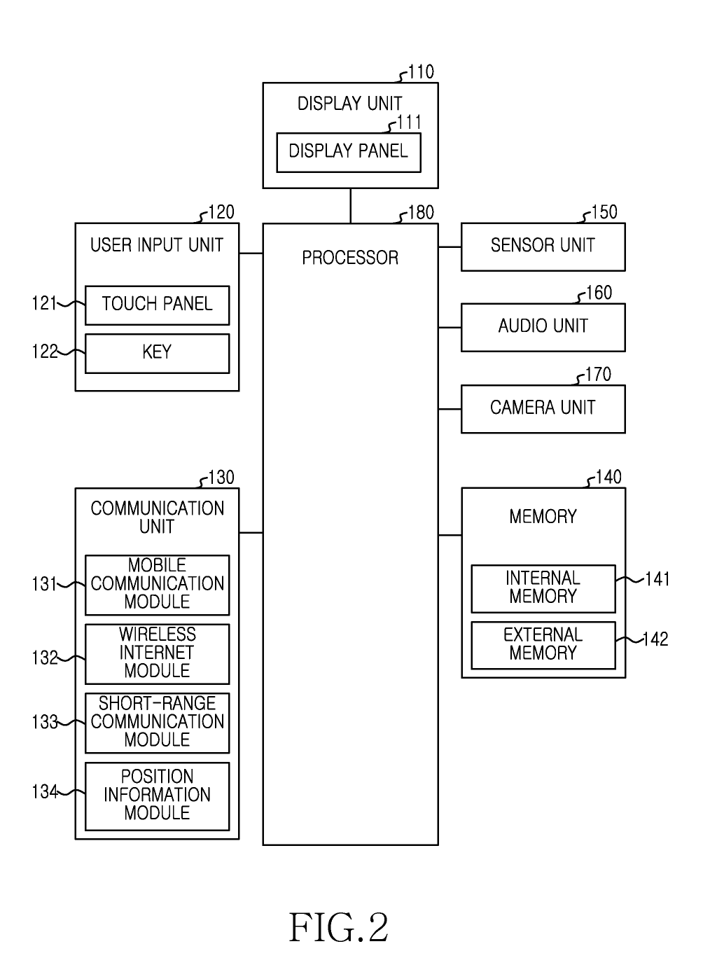

FIG. 2 is a configuration view of the user terminal device 100 according to an embodiment of the present disclosure.

The user terminal device 100 may include a display unit 110, a user input unit 120, a communication unit 130, a memory 140, a sensor unit 150, an audio unit 160, a camera unit 170, and a processor 180. Although an example of the configuration of the user terminal device 100 is shown in FIG. 2, other components may be further included in addition thereto. Also, at least two components may be integrated as a single component or a single component may be divided into at least two components. In addition, one or more components may be omitted from the user terminal device 100.

Referring to FIG. 2, the display unit 110 may display images or data to the user. The display unit 110 may include a display panel 111. The display panel 111, for example, may be one of a liquid crystal display (LCD) and an active matrix organic light emitting diode (AM-OLED). Herein, the display unit 110 may further include a controller for controlling the display panel 111. The display unit 110, for example, may be formed to be flexible, transparent, or wearable. The display unit 110 may be a touch screen coupled with a touch panel. For example, the touch screen may be configured as a single module coupled with the display panel 111 and the touch panel 121 as a lamination.

The user input unit 120 may receive various commands from the user. The user input unit 120, for example, may include at least one of the touch panel 121 and a key 122.

The touch panel 121, for example, may recognize a touch input of the user through at least one of capacitive sensing, pressure sensing, and ultrasound sensing. When being configured as an electrostatic sensing type, the touch panel 121 may sense a change in capacitance according to a distance from a finger of the user and may generate one of a touch event and a hovering event according to a level of the change in capacitance. Herein, the touch event may be generated when the touch screen is in contact with the finger of the user. Also, the hovering event may be generated when the user terminal device 100 recognizes the finger of the user and a position of the finger of the user on the touch screen is detected. The touch panel 121 may transmit one of touch position information and hovering position information according to one of the touch event and the hovering event.

The key 122, for example, may be one of a mechanical key and a touch key. The mechanical key, for example, may include a power button provided on one side of a user terminal that may turn a screen on when being pushed or a volume button that may control volume when being pushed. Also, the mechanical key may include a home button providing a home screen when being pushed. The touch key, for example, may include a menu key providing a menu related to contents being displayed on a screen when being touched or a return key providing a function of returning to a previous screen when being touched.

The communication unit 130 may include at least one of a mobile communication module 131, a wireless Internet module 132, a short-range communication module 133, and a position information module 134.

The mobile communication module 131 transmits and receives a wireless signal with at least one of a base station, an external terminal, and a server on a mobile communication network. The wireless signal may include data having various forms according to transmission and reception of a voice call signal, a video communication call signal, or a text/multimedia message.

The wireless Internet module 132 performs a function for wirelessly accessing the Internet. As wireless Internet technology, wireless local area network (LAN) (WLAN) Wi-Fi, wireless broadband (Wibro), world Interoperability for microwave access (Wimax), high speed downlink packet access (HSDPA), etc. may be used.

The short-range communication module 133 performs a function for LAN communication. As LAN communication technology, Bluetooth, radio frequency identification (RFID), infrared data association (IrDA), ultra wideband (UWB), ZigBee, etc. may be used.

The position information module 134 performs a function of obtaining or checking a position of a mobile terminal. The position information module 134 may obtain position information using a global navigation satellite system (GNSS). Herein, the GNSS is used to describe wireless navigation satellite systems revolving around the earth and transmits reference signals to allow certain types of wireless navigation receivers to determine positions thereof on the surface of the earth or near thereto. As the GNSS, there are a global positioning system (GPS) operated by United States of America (USA), Galileo operated by European Union (EU), a global orbiting navigation satellite system (GLONASS) operated by Russia, COMPASS operated by China, and a Quasi-Zenith Satellite system.

In addition, the communication unit 130 may include one of a network interface such as a LAN card and a modem to connect the user terminal device 100 to a network, for example, Internet, LAN, wire area network (WAN), telecommunication network, cellular network, satellite network, plain old telephone services (POTS), and etc.

The memory 140 may include at least one of an internal memory 141 and an external memory 142.

The internal memory 141, for example, may include at least one of a volatile memory such as a dynamic random-access memory (RAM) (DRAM), a static RAM (SRAM), a synchronous dynamic RAM (SDRAM), etc., a nonvolatile memory such as a one time programmable read-only memory (ROM) (OTPROM), an erasable and programmable ROM (EPROM), an electrically erasable and programmable ROM (EEPROM), a mask ROM, a flash ROM, etc., a hard disk drive (HDD), and a solid state drive (SSD). According to embodiments, the processor 180 may load commands or data received from at least one of a nonvolatile memory and another component onto a volatile memory to process. Also, the processor 180 may store data received or generated from another component in a nonvolatile memory.

The external memory 142, for example, may include at least one of a compact flash (CF) memory, a secure digital (SD) memory, a micro-SD memory, a mini-SD memory, and extreme digital (xD) memory, and a memory stick.

The memory 140 may store an operating system controlling resources of the user terminal device 100 and an application program for operating an application. The operating system may include a kernel, middleware, and an application program interface (API). As the operating system, for example, Android, iOS, Windows, Symbian, Tizen, or Bada operating system may be used.

The kernel may include a system resource manager capable of controlling resources and a device driver. The resource manager, for example, may include a processor management unit, a memory management unit, and a file system management unit and may perform functions of controlling, allocating, and collecting system resources. The device driver accesses various components of the user terminal device 100 as software to control. For this, the device driver may be divided into an interface and an individual driver module provided by each hardware provider. The device driver, for example, may include at least one of a display driver, a camera driver, a Bluetooth driver a common memory driver, a universal serial bus (USB) driver, a keypad driver, a Wi-Fi driver, an audio driver, and an inter-process communication (IPC) driver.

The middleware may be configured including a plurality of modules previously formed to provide functions used by various applications in common. The middleware may provide functions used in common through an API to allow an application to effectively use limited system resources in an electronic device. The middleware, for example, may include at least one of an application manager, a Window manager, a multimedia manager, a resource manager, a power manager, a database manager, and a package manager. Also, in some cases, the middleware may include a connectivity manager, a notification manager, a location manager, a graphic manager, and a security manager. Also, the middleware, in some cases, may include a runtime library and other library modules. The runtime library may be used by a comfier to add a new function through a programming language while an application is being executed. For example, the runtime library may perform functions related to input/output, memory management, and computational functions. The middleware may be a new middleware module generated by using a combination of various functions of internal component modules described above. On the other hand, the middleware may be provided as a module specialized for each kind of an operating system to provide a particular function.

The API is a set of API programming functions, which may be provided as a different component according to operating systems. For example, a single API set may be provided for each platform in Android and iOS and two or more API sets may be provided in Tizen.

An application may perform at least one function using an application program. The application, for example, may be divided into a preloaded application and a third party application. The application, for example, may include a home application for executing a home screen, a dialer application, a short message service (SMS)/multimedia messaging service (MMS) application, a messenger application such as Kakao Talk and Chat on, a browser application, a camera application, an alarm application, a contact or address book application, a voice dial application, an email application, a calendar application, a media player application, an album application, and a clock application.

The sensor unit 150, for example, may include at least one of a gesture sensor, a gyro sensor, a magnetic sensor, an acceleration sensor, a proximity sensor, and an illuminance sensor.

The audio unit 160 may bidirectionally convert a voice and an electric signal into each other. The audio unit 160, for example, may include at least one of a speaker, a receiver, an earphone, and a microphone to convert inputted or outputted voice information.

The camera unit 170 may perform a function of taking pictures or moving pictures. The camera unit 170, in some cases, may include one or more image sensors, for example, a front lens and a rear lens (not shown), an image signal processor (ISP) (not shown), and a flash light emitting diode (LED).

The processor 180, driving an operating system and an application program, may control a plurality of hardware and software components connected to the processor 180 and may process and compute various types of data including multimedia data. For example, the processor 180 may provide a user interface to search for goods that the user would like to purchase by executing a market application, to display a message of confirming whether the goods are purchased by executing a messenger application, and to select a seller capable of sharing payment information of the user. The processor 180, for example, may be a system on chip (SoC) and may further include a graphic processing unit (GPU).

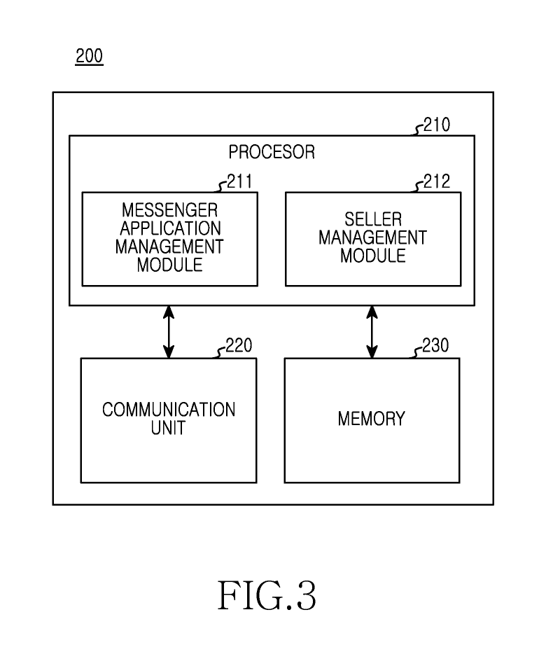

FIG. 3 is a configuration view of the messenger server 200 according to an embodiment of the present disclosure.

Referring to FIG. 3, the messenger server 200 may include a processor 210, a communication unit 220 and a memory 230.

The processor 210 of the messenger server 200 may control a plurality of hardware and software components of the messenger server 200, connected to the processor 210, by driving an operating system and an application program of the messenger server 200. The processor 210 may include a messenger application management module 211 and a seller management module 212.

The messenger application management module 211 may manage transmission, reception, or storage of a message, interworking with a messenger application of the user terminal device 100. Also, the messenger application management module 211 may control one of a list of friends of the user of the user terminal device 100 (hereinafter, referred to as a friend list) and a list of friend candidates capable of being included in the friend list (hereinafter, referred to as a friend candidate list).

The seller management module 212 may manage transmission, reception, and storage of signals for performing payment services, interworking with one of the seller server 300 and the payment server 400. Also, the seller management module 212, in response to a signal for requesting a payment of the goods from the seller server 300, may determine whether the seller server 300 is able to share payment information of the user, previously registered in the messenger server 200. Also, when the sharing of the payment information is possible, the seller management module 212 may allow the communication unit 220 to transmit the signal for requesting the payment of the goods to the payment server 400.

The communication unit 220 of the messenger server 200 may perform communication with the user terminal device 100, the seller server 300, and the payment server 400. For example, the communication unit 220 may receive a signal requesting that a seller be added to the friend candidate list from the seller server 300 and transmit a signal indicating that the adding of the seller to the friend candidate list is completed or not completed according to a processing result of the messenger application management module 211. Otherwise, the communication unit 220 may transmit a signal requesting a payment of the goods selected by the user to the payment server 400 and may receive a signal indicating that the payment of the goods is completed or not completed from the payment server 400 according to a processing result of the payment server 400.

The memory 230 of the messenger server 200 may temporarily or permanently store payment information or payment-interworked information of the user. The payment-interworked information of the user may be information of the user accessing the messenger server 200. For example, the payment-interworked information may be at least one of an account ID of the user and personal information of the user, for example, name, birth date, sex, address, etc. The payment information of the user is for purchasing goods, for example, which may be at least one of information on cards possessed by the user and billing information such as provider billing, for example, a phone bill and a premium SMS, and local billing for each region, for example, cyber cash, a prepaid card, and web money. For example, the payment information may be one of the number, a card validation code, and the expiration date of a credit card. Herein, the payment information, for security, may be encoded and stored as an exclusive number.

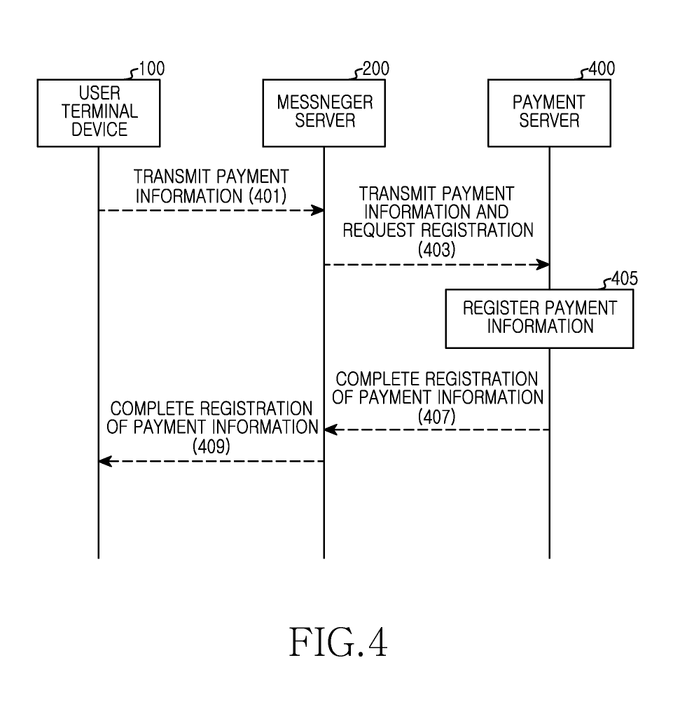

FIG. 4 is a view of a process of registering payment information of the user terminal device 100 according to an embodiment of the present disclosure.

Referring to FIG. 4, the user terminal device 100 may transmit payment information to the messenger server 200 in operation 401. To allow the payment information to be transmitted to the messenger server 200, the user terminal device 100 may receive the payment information from the user. The user terminal device 100 may receive the payment information using a messenger application. The messenger server 200 transmits the received payment information to the payment server 400 and may transmit a signal requesting the registration of the payment information to the payment server 400 in operation 403. The payment server 400 may previously register the payment information of the user using the transmitted payment information before paying for the goods in operation 405. Also, the payment server 400 may transmit a signal notifying that the registration of the payment information is completed, to the messenger server 200 in operation 407. The messenger server 200 may transmit the signal notifying that the registration of the payment information is completed, to the user terminal device 100 in operation 409.

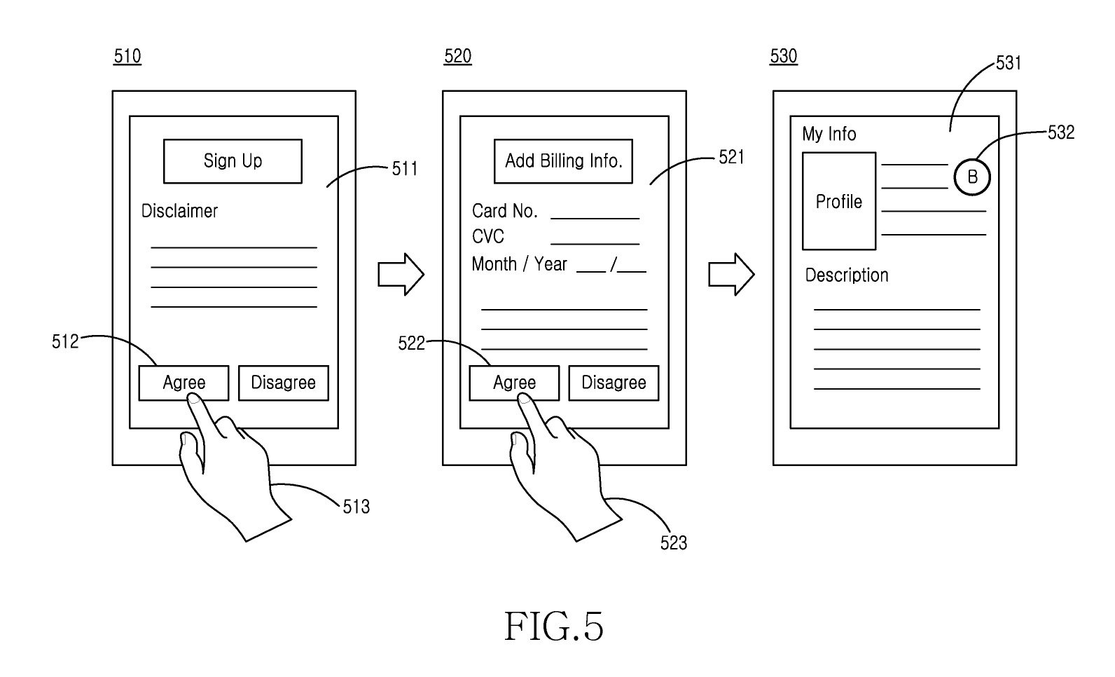

FIG. 5 is a view of a process of registering payment information using a messenger application in the user terminal device 100 according to an embodiment of the present disclosure.

Referring to FIG. 5, the user terminal device 100 may execute the messenger application according to a request of the user. In 510 of FIG. 5, the user terminal device 100 may display a membership application screen 511 for confirming whether the user is a member of a messenger. The user may perform a user gesture 513, for example, a tap for selecting an agreement button 512 included in the membership application screen 511.

In 520 of FIG. 5, in response to the user gesture 513, the user terminal device 100 may display a payment information addition screen 521 to receive the payment information of the user. The payment information addition screen 521, for example, may include at least one field for receiving information related to a credit card. Herein, the user terminal device 100 may provide the payment information addition screen 521 through an additional menu, for example, a configuration in the messenger application, instead of displaying the payment information addition screen 521 next to the membership application screen 511. The user may input the payment information in the at least one field included in the payment information addition screen 521 and may perform a user gesture 523, for example, a tap for selecting an agreement button 522.

In 530 of FIG. 5, in response to the user gesture 523, the user terminal device 100 may register the payment information in one of the messenger server 200 and the payment server 400. Herein, the registering of the payment information using the messenger server 200 may include allowing the user terminal device 100 to transmit the payment information to the messenger server 200, allowing the messenger server 200 to transmit the received payment information to the payment server 400, and allowing the payment server 400 to register the payment information. Alternatively, the registering of the payment information using the messenger server 200 may include storing the payment information in the messenger server 200 to allow the messenger server 200 to share the payment information with at least one seller. The user terminal device 100 may display a membership information screen 531 including a visual feedback, for example, a payment registration icon 532, which indicates that the payment information is registered, as a result of registering the payment information.

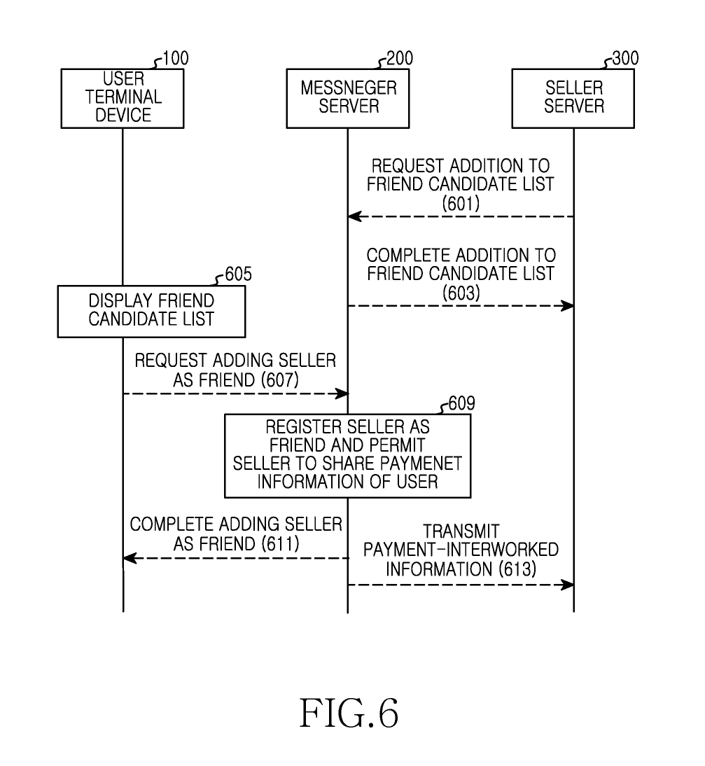

FIG. 6 is a view of a process of registering a seller as a friend of the user of the user terminal device 100 according to an embodiment of the present disclosure.

Referring to FIG. 6, the seller server 300 may transmit a signal requesting that a seller be added to a friend candidate list, to the messenger server 200 in operation 601. For example, when the messenger server 200 manages the friend candidate list of the user, the seller server 300 may transmit a signal requesting that information on the seller be included in the friend candidate list. The information on the seller, for example, may be a company name and a logo image of the seller managing the seller server 300. Herein, the friend candidate list may include sellers capable of sharing payment information. For example, sellers, from which the user has ever purchased goods, or sellers allowed to be put on the friend candidate list may be displayed in the friend candidate list. When the information on the seller is included in the friend candidate list, the messenger server 100 may transmit a signal notifying that the seller is added to the friend candidate list, to the seller server 300 in operation 603. The user terminal device 100 may display the friend candidate list including sellers through the display unit 110 when a messenger application is executed in operation 605. The user terminal device 100 may transmit a signal requesting that the seller selected by the user from the displayed list of friend candidates be added as a friend, to the messenger server 200 in operation 607. For example, the user terminal device 100 may add the seller selected by the user from the displayed friend candidate list as a friend and may transmit a result of the addition to the messenger server 200. In detail, when the messenger application is KakaoTalk, the user terminal device 100 may obtain names or identifiers such as phone numbers of friends and sellers registered as friends through a structured query language (SQL) query from KakaoTalk.db files, which are database files of KakaoTalk application. Then, the user terminal device 100 may transmit an obtained friend list to be included in a friend list of the user, managed by the messenger server 200. The friend list, for example, may be considered as a group consisting of opponents designated by the user to be easily accessible and to be separately managed from opponents, which the user contacts or by which the user is contacted using a phone number thereof or which the user contacts or by which the user is contacted using account ID thereof. The messenger server 200 may register the seller recommended to be added as a friend from the user terminal device 100, in the friend list of the user, managed by the messenger server 200 in operation 609. Also, the messenger server 200 may previously permit the seller, which is the friend of the user, to share the payment information of the user before payment in operation 609. The messenger server 200 may transmit a signal notifying that the seller is added as the friend to the user terminal device 100 as a result of putting the seller on the friend list of the user in operation 611. Also, the messenger server 200 may transmit payment-interworked information of the user to the seller server 300 as a result of permitting the seller to share the payment information in operation 613. The payment-interworked information, for example, may include one of account ID and personal information of the user to be connected to the messenger server 200.

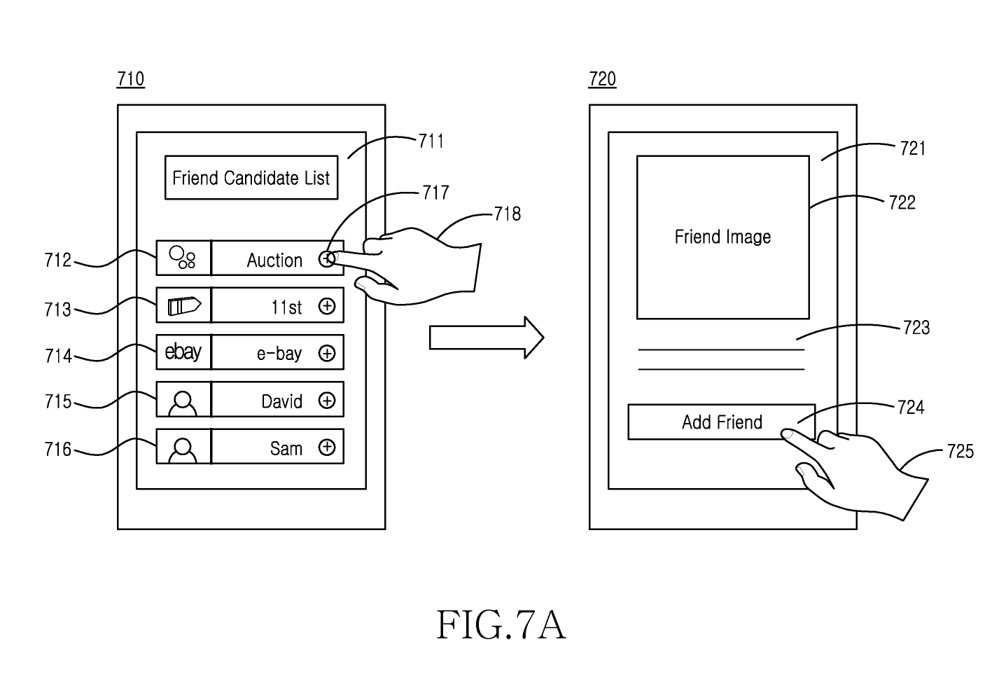

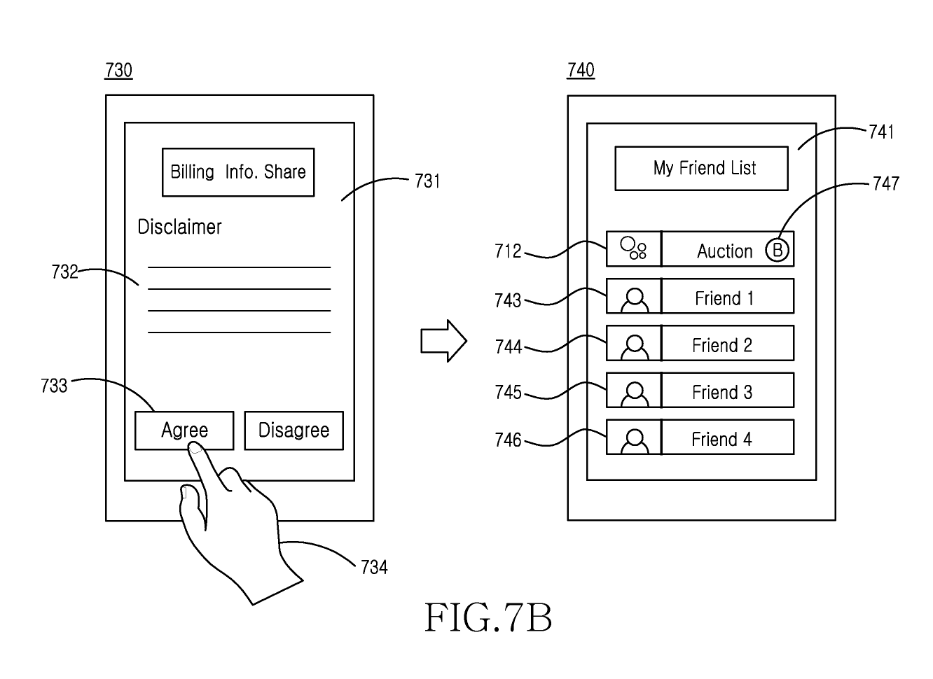

FIGS. 7A and 7B are views of a process of registering a seller as a friend of the user using a messenger application according to an embodiment of the present disclosure.

Referring to FIG. 7A, in 710, the user terminal device 100 may display a friend candidate list screen 711 using the messenger application. The friend candidate list screen 711 may be displayed with one or more sellers 712, 713, and 714 capable of being registered as a friend. The friend candidate list screen 711 may be displayed being divided into a list of the sellers 712, 713, and 714 and a list of personal friends 715 and 716. However, it is possible to display in an order of being put on the friend candidate list. The user may perform a user gesture 718, for example, a tap for selecting an addition button 717 to be provided with detailed information on the seller 712 among the friend candidate list.

In 720 of FIG. 7A, in response to the user gesture 718, the user terminal device 100 may display a friend information screen 721 providing the detailed information on the seller 712. The friend information screen 721 may include an image 722 related to the seller 712 and detailed contents 723 with respect to the seller 712. The user may perform a user gesture 725, for example, a tap for selecting a friend addition button 724 for adding the seller 712 as a friend on the friend information screen 721.

In 730 of FIG. 7, in response to the user gesture 725, the user terminal device 100 may add the seller 712 as the friend and may display a payment information sharing screen 731 for confirming whether to share payment information. The payment information sharing screen 731 may include information 732 filled with security details according to sharing the payment information. The user may perform a user gesture 734 for selecting an agreement button 733 for allowing the seller 712 to share the payment information of the user on the payment information sharing screen 731.

In 740 of FIG. 7B, in response to the user gesture 734, the user terminal device 100 may allow the seller 712 being the friend thereof to share the payment information. Also, the user terminal device 100 may display a friend list screen 741, in which the seller 712 is included in the friend list of the user. The friend list screen 741 may be displayed with the seller 712 newly registered as the friend and friends 743, 744, 745, and 746 previously registered as friends of the user. Herein, a visual feedback 747 indicating that the payment information may be shared when paying for goods may be displayed on the seller 712 allowed to share the payment information As described above, according to the embodiments, sellers are registered as friends, thereby easily managing the seller. Also, only the sellers registered as friends are allowed to share payment information, thereby increasing security. That is, only the sellers permitted by the user are capable of using the payment information, thereby protecting the payment information from being indiscriminately illegal used.

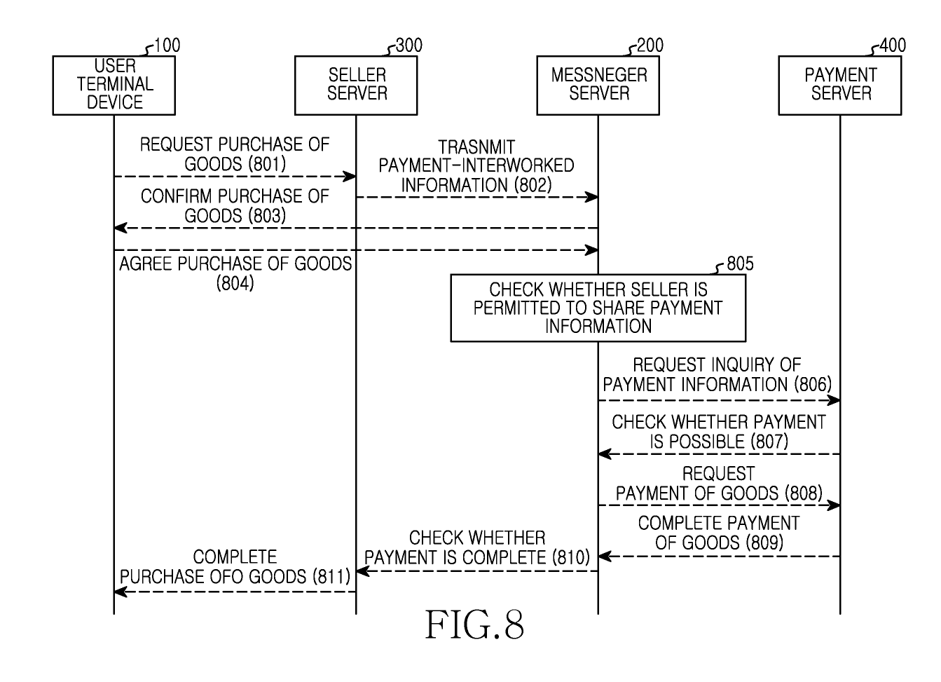

FIG. 8 is a view of a process of performing a payment while the user terminal device 100 is interworking with the messenger server 200 according to an embodiment of the present disclosure.

Referring to FIG. 8, when the user requests a purchase of goods provided by a seller using a market application, a signal requesting the purchase of the goods selected by the user may be transmitted to the seller server 300 in operation 801. The seller server 300, in response to a purchase request signal, may transmit payment-interworked information to the messenger server 200 in operation 802. The messenger server 200, in response to the transmitted payment-interworked information, may transmit a signal confirming the purchase of the goods to the user terminal device 100 in operation 803. The user terminal device 100 may provide the user with a message for confirming the purchase using a messenger application. When the user agrees to the purchase, the user terminal device 100 may transmit a signal for agreeing to the purchase of the goods to the messenger server 200 in operation 804. The messenger server 200, when the agreement of the purchase of the goods is confirmed, may check whether a seller is permitted by the user to share payment information in operation 805. Herein, transmitting, by the messenger server 200, the signal confirming the purchase to the user in operation 803 and receiving the signal for agreeing to the purchase from the user in operation 804 may be omitted in some cases. When the seller is a seller permitted to share the payment information as confirmed by a result of checking the validity of the seller, the messenger server 200 may transmit a signal requesting an inquiry of the payment information of the user to check whether the user is capable of paying for the goods, to the payment server 400 in operation 806. The payment server 400, in response to the inquiry request signal, may inquire of whether the user is capable of paying for the goods. When it is possible to pay for the goods, the payment server 400 may transmit a signal notifying that the user is capable of paying for the goods, to the messenger server 200 in operation 807. The messenger server 200, in response to the signal notifying that the user is capable of paying for the goods, may transmit a signal requesting the payment of the goods to the payment server 400 in operation 808. Also, the payment server 400 may pay for the goods and may transmit a signal notifying that the payment of the goods is completed, to the messenger server 200 in operation 809. The messenger server 200 may transmit a signal notifying that the payment of the goods is completed, to the seller server 300 in operation 810. The messenger server 200, as the payment of the goods is completed, may transmit a signal notifying that the purchase of the goods is completed, to the user terminal device 100 in operation 811. As described above, the seller server 300 may process the payment of the goods by transmitting payment-interworked information to the messenger server 200 without asking the user for the payment information. Particularly, when a function of performing payment services using the messenger server 200 is provided as an API to sellers, the sellers may easily apply the function to a seller server, thereby increasing profits thereof. As described above, since it becomes easy to purchase goods by using the messenger server 200, profits of sellers may increase and the sellers may provide a messenger provider with a certain portion of the profits. Accordingly, a function of calculating the profits of the sellers and a profit of the provider may be further included.

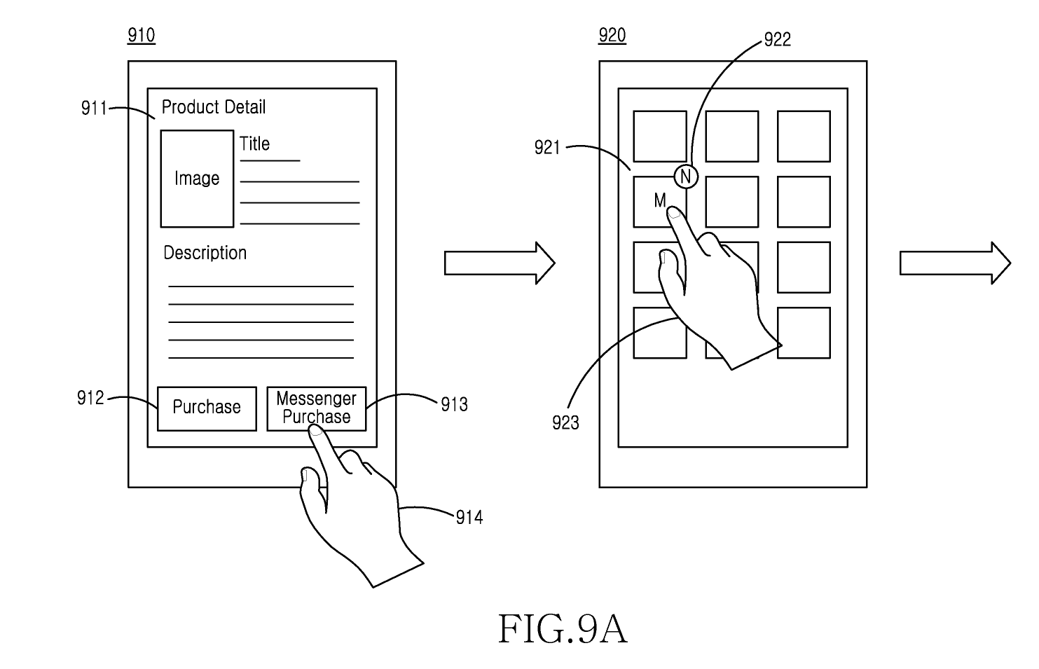

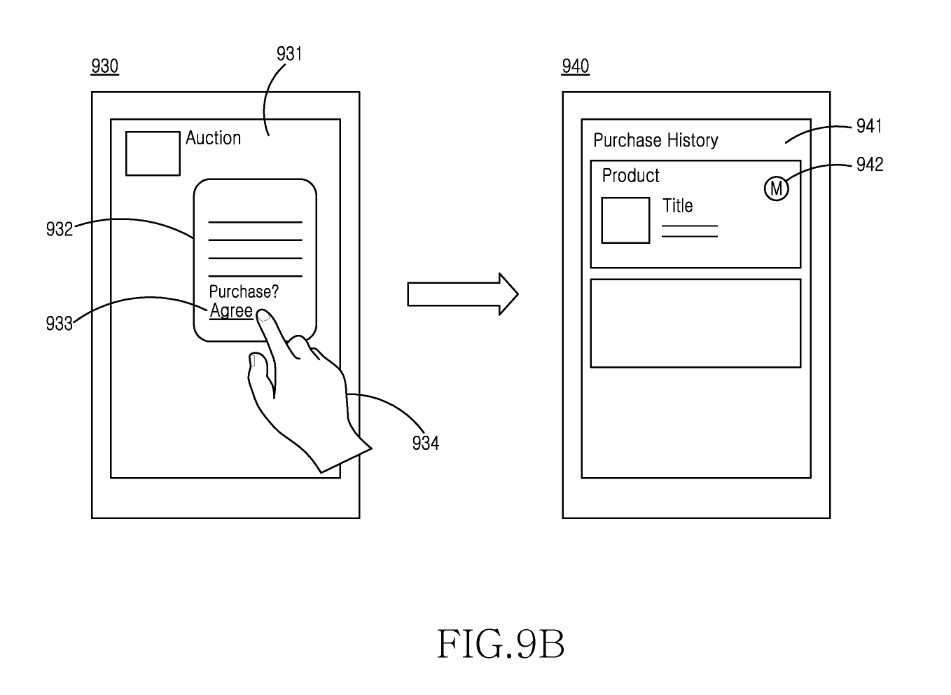

FIGS. 9A and 9B are views of a process of performing a payment using a messenger application in the user terminal device 100 according to an embodiment of the present disclosure.

In 910 of FIG. 9A, the user may execute a market application to search for goods that the user would like to purchase. A screen 911 shows that the market application is executed and detailed information of the goods is displayed. The screen 911 may include purchase buttons 912 and 913 for agreeing to purchase the goods. The purchase button 912 may be a button for purchasing the goods using payment services specialized for the seller server 300, provided by a general market application. The messenger purchase 913 may be a button for purchasing the goods using payment services provided by the messenger application according to the embodiments. The user may perform a user gesture 914, for example, a tap for selecting the messenger purchase button 913. The seller server 300 may transmit payment-interworked information to the messenger server 200 as a selection of the user for the messenger purchase button 913. Herein, in response to the payment-interworked information, the messenger server 200 may provide a messenger application installed in the user terminal device 100 with a message for confirming the purchase.

In 920 of FIG. 9A, when the user terminal device 100 receives the message for confirming the purchase, a shortcut icon of the messenger application, on an application list screen 921, may be displayed with an identifier 922 indicating that a new message is received. The user may check for the receiving of the new message and may perform a user gesture 923, for example, a tap for displaying the messenger application on a screen.

In 930 of FIG. 9B, in response to the user gesture 923, the user terminal device 100 may display a messenger screen 931 provided by the messenger application. The messenger screen 931 may be displayed with a message 932 for confirming the purchase of the goods requested by the user. The message 932, for example, may include information and a price of the goods. The user may perform a user gesture 934, for example, a tap for selecting a user interface 933 agreeing to the purchase of the goods included in the message 932. In response to the user gesture 934 agreeing to the purchase, the messenger application may transmit a signal for agreeing to the purchase to the messenger server 200. The messenger server 200 may check whether a seller is permitted by the user to share payment information. When the seller is permitted to share the payment information, the messenger server 200 may transmit a signal requesting a payment of the goods to the payment server 400. In response to this, the payment server 400 may pay for the goods and may transmit a signal notifying that the payment of the goods is completed, to the messenger server 200. The messenger server 200 may transmit a signal notifying that the payment of the goods is completed, to the seller server 300.

In 940 of FIG. 9B, according to the completion of the purchase of the goods, the seller server 300 may provide a visual feedback 942 indicating that the purchase of the goods is completed using the messenger server 200, on a screen 941 of a market application.

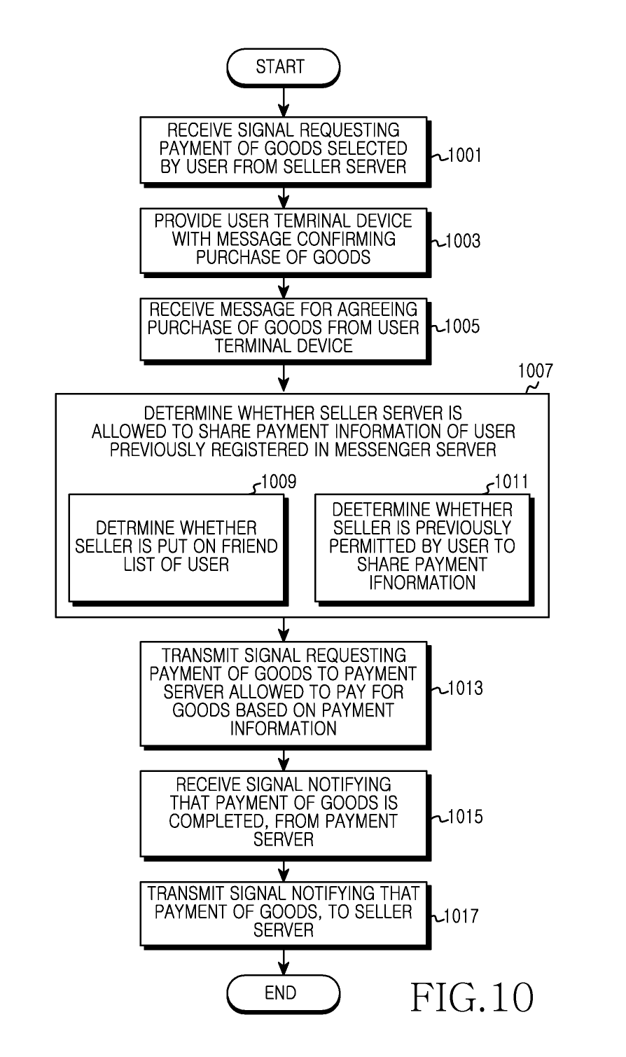

FIG. 10 is a flowchart illustrating a method of providing payment services while the messenger server 200 is interworking with the seller server 300 according to an embodiment of the present disclosure.

Referring to FIG. 10, the messenger server 200 may receive a signal requesting a payment of goods selected by the user from the seller server 300 at operation 1001. For example, the messenger server 200 may receive payment-interworked information as the signal requesting the payment of the goods. Also, the messenger server 200 may provide the user terminal device 100 with a message confirming the purchase of the goods at operation 1003. Also, in response to the user agreeing to the purchase of the goods, the messenger server 200 may receive a message notifying that the user agrees to the purchase of the goods from the user terminal device 100 at operation 1005. The messenger server 200 may determine whether the seller server 300 is able to share payment information of the user, previously registered in the messenger server 200 at operation 1007. For example, the messenger server 200 may determine whether a seller using the seller server 300 is put on a friend list of the user at operation 1009. Also, the messenger server 200 may determine whether the seller using the seller server 300 is previously permitted by the user to share the payment information at operation 1011. The messenger server 200 may perform both operations 1009 and 1011 or may perform only one of the operations 1009 and 1011. Also, the operation 1011 may be performed after performing the operation 1009 or the operation 1009 may be performed after performing the operation 1011. Also, the operations 1009 and 1011 may be performed at the same time. When the seller is able to share the payment information from a result of the determination, the messenger server 200 may transmit a signal requesting a payment of the goods to the payment server 400 able to pay for the goods based on the payment information at operation 1013. Also, as the payment of the goods is performed, the messenger server 200 may receive a signal notifying that the payment of the goods is completed from the payment server 400 at operation 1015. The messenger server 200 may transmit a signal notifying that the payment of the goods is completed, to the seller server 300 in operation 1017.

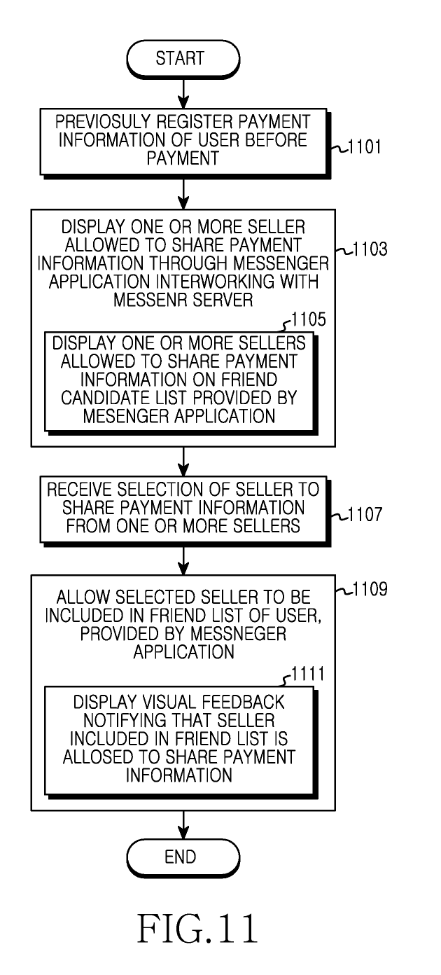

FIG. 11 is a flowchart illustrating a method, in which the user terminal device 100 puts a seller on a friend list using a messenger application according to an embodiment of the present disclosure.

Referring to FIG. 11, the user terminal device 100 may previously register payment information of the user using the messenger server 200 before payment at operation 1101. For example, the user terminal device 100 may register the payment information of the user in the payment server 400 through the messenger server 200 or may register the payment information in the messenger server 200. Then, the user terminal device 100 may display at least one seller able to share the payment information using the messenger application interworking with the messenger server 200 at operation 1103. For example, the user terminal device 100 may display at least one seller able to share the payment information on a friend candidate list provided by the messenger application at operation 1105. Next, the user terminal device 100 may receive a selection of the user for a seller to share the payment information among the displayed sellers at operation 1107. In response to the selection of the user, the user terminal device 100 may allow the selected seller to be included in the friend list of the user, provided by the messenger application at operation 1109. Herein, a visual feedback notifying that the seller on the friend list is able to share the payment information at operation 1111.

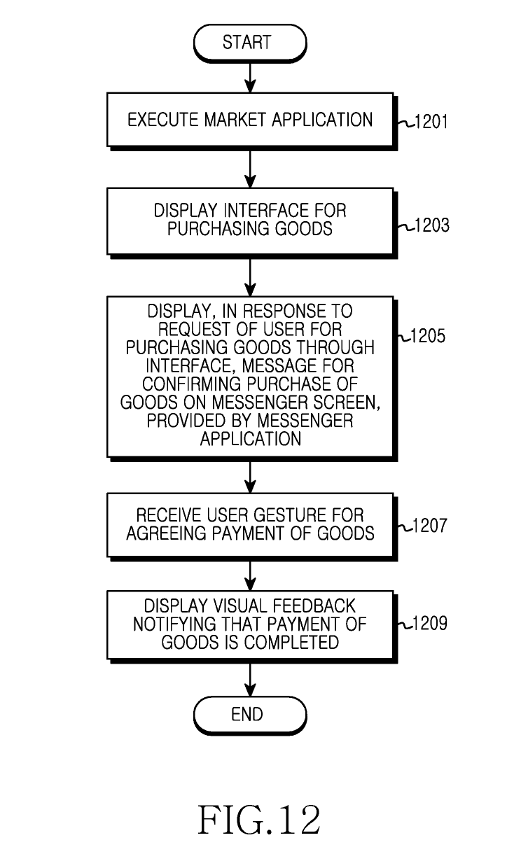

FIG. 12 is a flowchart illustrating a method, in which the user terminal device 100 provides payment services using a messenger application according to another embodiment of the present disclosure.

Referring to FIG. 12, the user terminal device 100 may execute a market application at operation 1201. On a screen executed with the market application, an interface for purchasing goods using payment services provided by the messenger application may be displayed at operation 1203. The user may request the purchase of goods through the interface. The user terminal device 100, in response to the request of the user for the purchase of the goods, may receive a message for confirming the purchase of the goods from the messenger server 200. Also, when the messenger application is executed, the user terminal device 100 may display the message for confirming the purchase of the goods on a messenger screen provided by the messenger application at operation 1205. For example, the message may be displayed with information on the goods and an interface for checking whether to agree to the purchase of the goods. The user terminal device 100 may receive a gesture of the user agreeing to a payment of the goods at operation 1207. Also, in response to the gesture of the user, the user terminal device 100 may display a visual feedback notifying that the payment of the goods is completed at operation 1209. The visual feedback, for example, may be displayed on the screen executed with the market application.

It will be known that the embodiments described above may be provided as one of hardware, software, and a combination thereof. Software described above, for example, regardless of being deletable or rerecordable, may be stored in one of a volatile or nonvolatile storage device such as a ROM, a random access memory (RAM), a memory chip, a memory such as an integrated circuit (IC), optically or magnetically recordable and computer-readable recording media such as a compact disk (CD), a digital versatile disk (DVD), a magnetic disk, a magnetic tape, etc.

The messenger server providing payment services, the method of providing payment services using the messenger server, the user terminal device executing the messenger application providing payment services, and the method of providing payment services using the messenger application disclosed herein may be provided by one of a computer and a user terminal device, including a processor and a memory. The memory may be a non-transitory computer-readable recording medium suitable for storing a program or programs including instructions to provide the embodiments. Accordingly, the disclosure herein includes a program including codes for embodying an apparatus or a method disclosed in a random one of the following claims and a non-transitory computer-readable recording medium storing the program. Also, the program may be electronically transmitted through a medium such as a communication signal transmitted through wired or wireless connection and the disclosure appropriately includes equivalents thereto. The messenger server providing payment services and the user terminal device executing the messenger application providing payment services may receive and store the program from a wired or wireless program providing apparatus. In addition, the user may select one of limiting the operations disclosed herein to be in the user terminal device and extending the operations to interwork with a server through a network.

According to the various embodiments, since the messenger server is directly interworking with seller servers, a plurality of sellers may be managed while being integrated. That is, the messenger server performs as a medium between a plurality of seller servers and the user terminal device, thereby simplifying a complicated process of connecting each of the seller servers to the user terminal device. Also, customer information is managed while being unified in the messenger server, thereby reducing a leakage of the customer information occurring due to the insecurity of a seller server.

Also, a payment is performed using an application familiar to the user, such as a messenger application, thereby increasing accessibility of the user using payment services.

Also, the messenger application limits the payment services to be used with sellers registered as friends in the messenger application, thereby increasing security to prevent an unconditional payment of the user.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in a user terminal device, the method comprising:
receiving a signal requesting a payment for goods selected by the user from a seller server;
determining, in response to the signal requesting the payment, payment information of the user, registered before the payment, to be sharable by the seller server when a seller using the seller server is present in a group consisting of opponents designated by the user through a messenger application among opponents of the user, registered in a messenger server;
transmitting a signal requesting the payment for the goods to a payment server using the payment information when the payment information is sharable; and
receiving a signal notifying that the payment of the goods is completed, from the payment server.

2. The method of claim 1, wherein the payment information of the user comprises at least one of information on a card possessed by the user, personal information of the user, and billing information of the user.

3. The method of claim 1, wherein the group consisting of the opponents designated by the user through the messenger application comprises a friend list consisting of opponents designated by the user as friends through the messenger application.

4. The method of claim 1, wherein the determining of the payment information of the user to be sharable by the seller server further comprises determining the payment information of the user to be sharable by the seller server when the seller using the seller server is previously permitted by the user to share the payment information.

5. The method of claim 1, wherein the receiving of the signal requesting the payment of the goods selected by the user from the seller server comprises receiving payment-interworked information of the user from the seller server, and
wherein the payment-interworked information comprises at least one of account identification of the user and personal information of the user to access the messenger server.

6. The method of claim 1, further comprising providing the user terminal device of the user with a message for confirming the purchase of the goods, after the receiving of the signal requesting the payment of the goods selected by the user from the seller server.

7. The method of claim 1, further comprising transmitting a signal notifying that the payment of the goods is completed, to the seller server.

8. A method in a user terminal device, the method comprising:
transmitting payment information of a user to a messenger server before a payment;
displaying one or more sellers allowed to share the payment information with the messenger server through a messenger application installed in the user terminal;
receiving a selection of at least one seller to share the payment information from the one or more sellers; and
displaying a visual feedback notifying that the selected seller is allowed to share the payment information.

9. The method of claim 8, further comprising allowing the selected at least one seller to be present in a group consisting of opponents designated by the user.

10. A method in a user terminal device, the method comprising:
displaying an interface for purchasing goods;
displaying a message for confirming the purchase of the goods on a messenger screen provided by a messenger application, in response to a request of a user for purchasing the goods through the interface; and
displaying a visual feedback notifying that a payment of the goods is completed, when an agreement about the goods is confirmed as a response with respect to the displayed message.

11. A messenger server comprising:
a processor configured to, in response to a signal requesting a payment of goods selected by the user from a seller server, when a seller using the seller server is present in a group consisting of opponents designated by the user through a messenger application from opponents of the user registered in the messenger server, determine payment information of the user to be sharable by the seller server; and
a communication unit configured to, when the payment information is sharable, transmit a signal requesting the payment of the goods to a payment server allowed to pay for the goods through the payment information and receive a signal notifying that the payment of the goods is completed, from the payment server.

12. The messenger server of claim 11, wherein the payment information of the user comprises at least one of information on a card possessed by the user, personal information of the user, and billing information of the user.

13. The messenger server of claim 11, wherein the group consisting of the opponents designated by the user through the messenger application comprises a friend list consisting of opponents designated by the user as friends through the messenger application.

14. The messenger server of claim 11, wherein the signal requesting the payment of the goods selected by the user comprises receiving payment-interworked information of the user, and
wherein the payment-interworked information comprises at least one of account identification of the user and personal information of the user to access the messenger server.

15. The messenger server of claim 11, wherein the communication unit provides the user terminal device of the user with a message for confirming a purchase of the goods.

16. The messenger server of claim 11, wherein the communication unit transmits a signal notifying that the payment of the goods is completed, to the seller server.

17. A user terminal device comprising:
a memory configured to store payment information of a user;
a display unit configured to display a screen provided by a messenger application; and
a processor configured to transmit the payment information to a messenger server before a payment, to receive a selection of at least one seller allowed to share the payment information through the messenger application interworking with the messenger server, and to control a visual feedback notifying that the selected at least one seller is allowed to share the payment information to be displayed on the display unit.

18. The user terminal device of claim 17, wherein the processor allows the selected at least one seller to be present in a group consisting of opponents designated by the user.

19. A user terminal device comprising:
a display unit configured to display an interface for purchasing goods; and
a processor configured to, in response to a request of a user for purchasing the goods through the interface, control a message for confirming the purchase of the goods on messenger screen provided by a messenger application to be displayed on the display unit.

20. A non-transitory recording medium recorded with a program for performing a method of providing payment services, the method comprising:
receiving a signal requesting a payment for goods selected by the user from a seller server;
determining, in response to the signal requesting the payment, payment information of the user, registered before the payment, to be sharable by the seller server when a seller using the seller server is present in a group consisting of opponents designated by the user through the messenger application among opponents of the user, registered in the messenger server;
transmitting a signal requesting the payment for the goods to a payment server using the payment information when the payment information is sharable; and
receiving a signal notifying that the payment of the goods is completed, from the payment server.
